(19) United States
(12) Patent Application Publication
(10) Pub. No.: US 2006/0252588 A1
(43) Pub. Date: Nov. 9, 2006

(54) Sprocket particularly for conveyor belts or chains

(75) Inventor: Sergio Fandella, Mogliano Veneto (IT)

Correspondence Address: MODIANO & ASSOCIATI, Via Meravigli, 16, MILAN, 20123, IT

(73) Assignee: PLASTOMECCANICA S.P.A.

(21) Appl. No.: 11/286,331

(22) Filed: Nov. 25, 2005

(30) Foreign Application Priority Data
May 4, 2005 (IT) TV2005A000061

(51) Int. Cl. F16H 55/00

(52) U.S. Cl. 474/47

(57) ABSTRACT

A modular sprocket, particularly for conveyor belts or chains, which comprises a spur gear, which is constituted by two spur halves, between which there is an opening which can accommodate internally a hub divided into two hub halves, the opening having a polygonal cross-section, which is shaped complementary with respect to the hub, interconnection elements for interconnecting the spur halves and for locking the hub being provided which can be accessed laterally with respect to the sprocket.

The present invention relates to a modular sprocket, particularly for conveyor belts or chains.

### BACKGROUND OF THE INVENTION

Sprockets provided with a substantially cylindrical hub, which can be keyed to a shaft, are currently used particularly for driving conveyor belts or chains.

In particular, U.S. Pat. No. 5,702,316 discloses a modular sprocket, which can be keyed to a shaft and comprises a spur gear obtained by joining two spur halves, which are substantially semicircular and between which there is, once they are mutually associated, a substantially cylindrical opening in which it is possible to arrange a hub, which can be divided into two semicylindrical hub halves and can be keyed to said shaft.

First through holes are formed radially in the spur halves, starting from some of the grooves formed between the pairs of consecutive teeth, and are faced by second threaded holes, which are formed radially in the outer lateral surface of the hub.

The two hub halves can be rigidly coupled to each other and to the hub, thus constituting the sprocket, by inserting in their first holes detachable fixing means, such as for example screws, which can be screwed into the second holes formed within the hub.

The two semicylindrical hub halves, which are substantially mirror-symmetrical, are kept joined during use by the two spur halves that enclose them.

The use of these known types of modular sprocket allows to use a same hub together with spur gears having different outside diameters and vice versa to use a same spur gear together with a plurality of hubs which have the same outside diameter and can be keyed to shafts of different diameters; this allows to reduce the production and storage costs of these sprockets.

It is further possible to assemble a hub and a spur gear made of two different materials, thus achieving a chosen combination of the different mechanical characteristics of the two materials.

The main drawback of these known types of sprocket is the particular substantially cylindrical shape of the hub, which has to be fixed to the spur halves by means of the screws or pins associated with the first and second holes.

In order to obtain the first and second holes, it is necessary to perform machining after the molding of the spur halves and hub halves, thus increasing the production costs of these modular sprockets.

Another drawback of known types of sprocket is that the first and second holes formed radially within the spur gear and the hub halves require high precision for their manufacture and constitute weak points which facilitate the formation of cracks or fractures, which over time can lead to the breakage of the spur halves or of the hub halves.

Another drawback is that the presence of the first holes formed in the grooves provided between the teeth of the spur gear constitute receptacles for dust or residues of the conveyed product; further, any loosening of the screws can cause vibrations, and if the head of said screws affects the curved surface that blends two consecutive teeth, it can cause jammings between said surface and the conveyor belt or chain with which it is associated, thus causing discontinuities in the motion of said chain or belt.

### SUMMARY OF THE INVENTION

The aim of the present invention is to solve the above-mentioned problems, eliminating the drawbacks of the cited background art, by providing a sprocket and a hub which can be mutually assembled and keyed to a shaft easily and rapidly, at the same time reducing the manufacturing and assembly costs.

Within this aim, an object of the invention is to provide a modular sprocket which allows to achieve optimum, rapid and safe interconnection between the sprocket and the hub.

Another object is to obtain a sprocket the components of which are simple, safe and quick to assemble even on the part of personnel that is not particularly trained.

Another object is to provide a sprocket which, once assembled and put to use, is free from problems related to jamming with a conveyor belt or chain associated therewith.

Another object of the invention is to obtain a modular sprocket in which the locking of the hub with respect to the spur gear can be achieved simply and rapidly.

Another object is to provide a sprocket which does not require to be subjected, for its manufacture, to mechanical machinings which might weaken its structure, consequently reducing its operating lifespan.

Another object is to provide a sprocket which is structurally simple and can be manufactured with conventional systems and machines, thus having low production costs.

This aim and these and other objects, which will become better apparent hereinafter, are achieved by a modular sprocket, particularly for conveyor belts or chains, which comprises a spur gear, which is constituted by two spur halves, between which there is an opening which can accommodate internally a hub divided into two hub halves, characterized in that said opening has a polygonal cross-section, which is shaped complementary with respect to said hub, means for interconnecting said spur halves and for locking said hub being provided which can be accessed laterally with respect to said sprocket.

### BRIEF DESCRIPTION OF THE DRAWINGS

Further characteristics and advantages of the invention will become better apparent from the following detailed description of a particular but not exclusive embodiment thereof, illustrated by way of non-limiting example in the accompanying drawings, wherein:

FIG. 1 is a perspective exploded view of a sprocket according to the invention;

FIG. 2 is an exploded side view of a sprocket according to the invention;

FIG. 3 is a side view of the assembled sprocket;

FIG. 4 is a side view of the assembled hub;

FIG. 5 is a front view of a spur half;

FIG. 6 is a partially sectional side view of a spur half;

FIG. 7 is a bottom view of the spur half of FIG. 6;

FIG. 8 is a front view of the two spur halves, arranged so as to face each other without being interconnected;

FIG. 9 is a side view of the two hub halves in the uncoupled condition;

FIG. 10 is a perspective view of a hub half;

FIG. 11 is a plan view of the hub half according to FIG. 10.

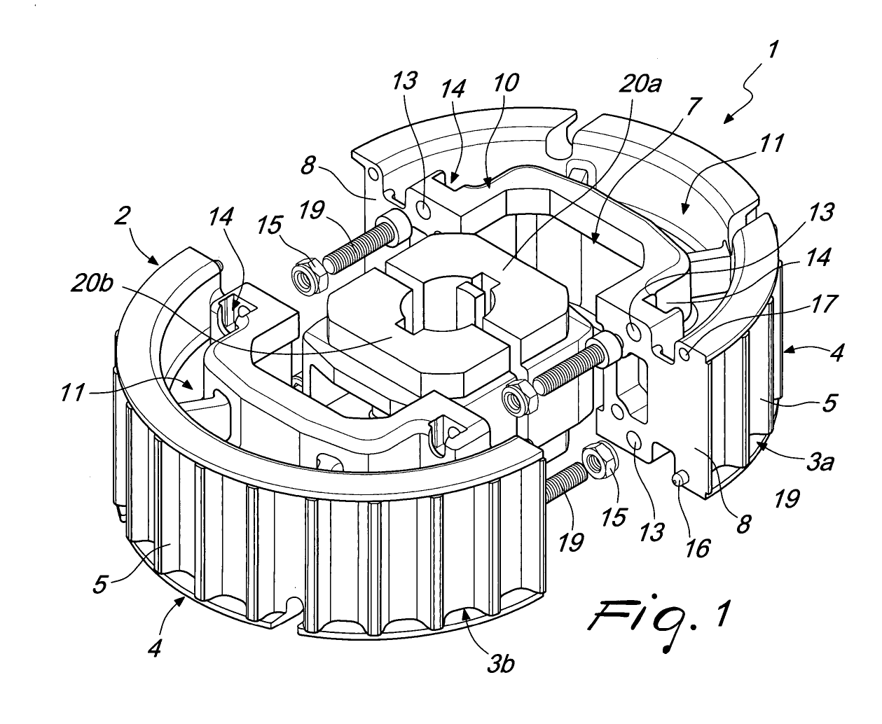

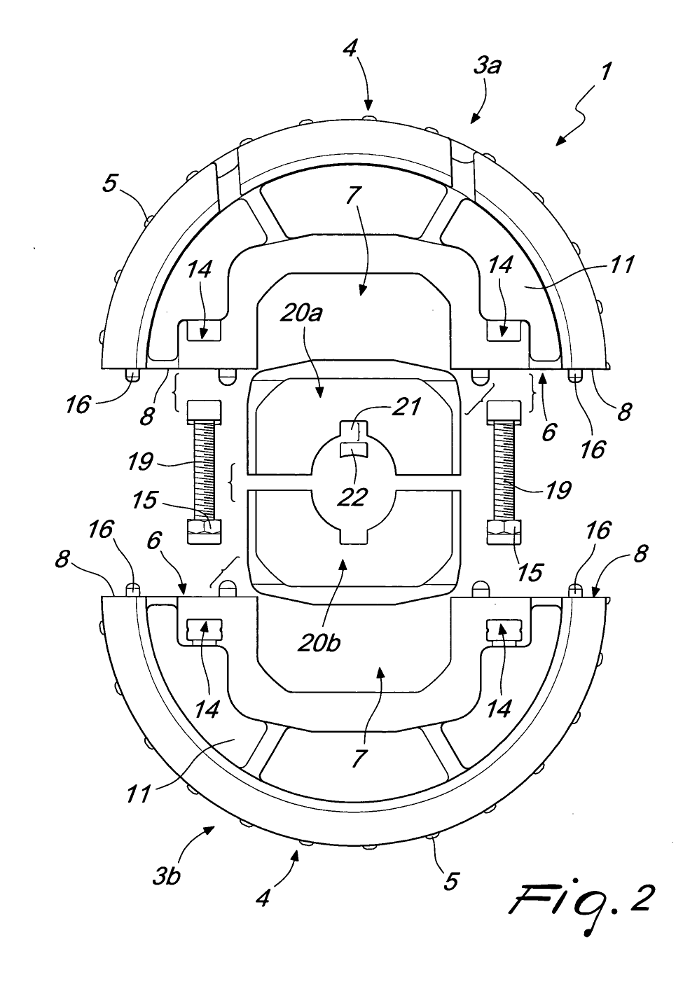

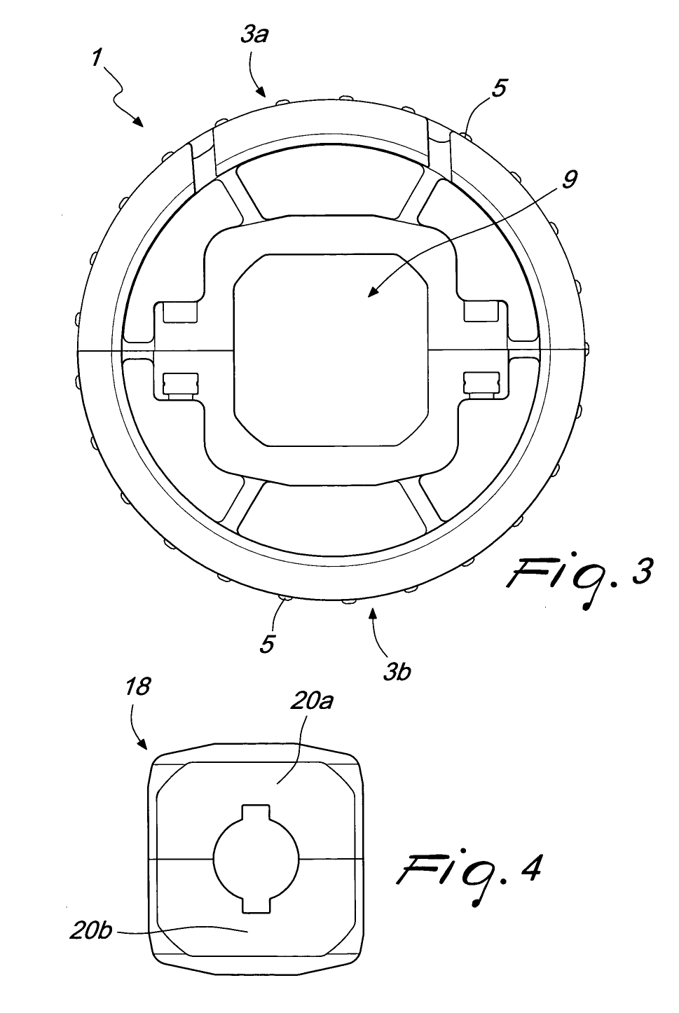

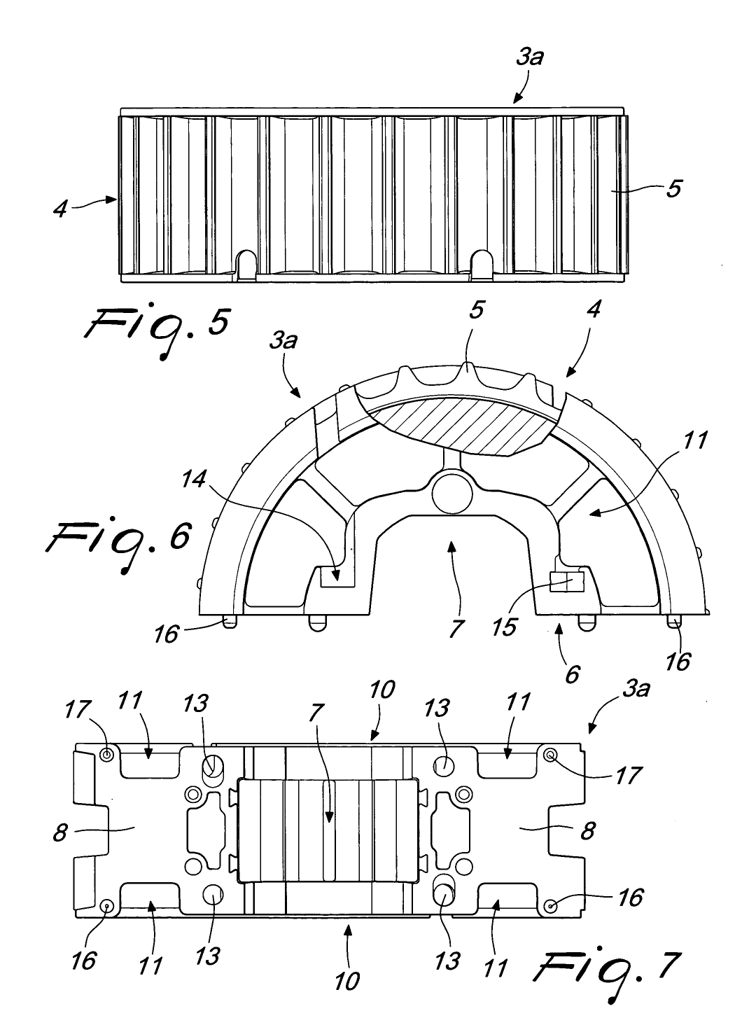

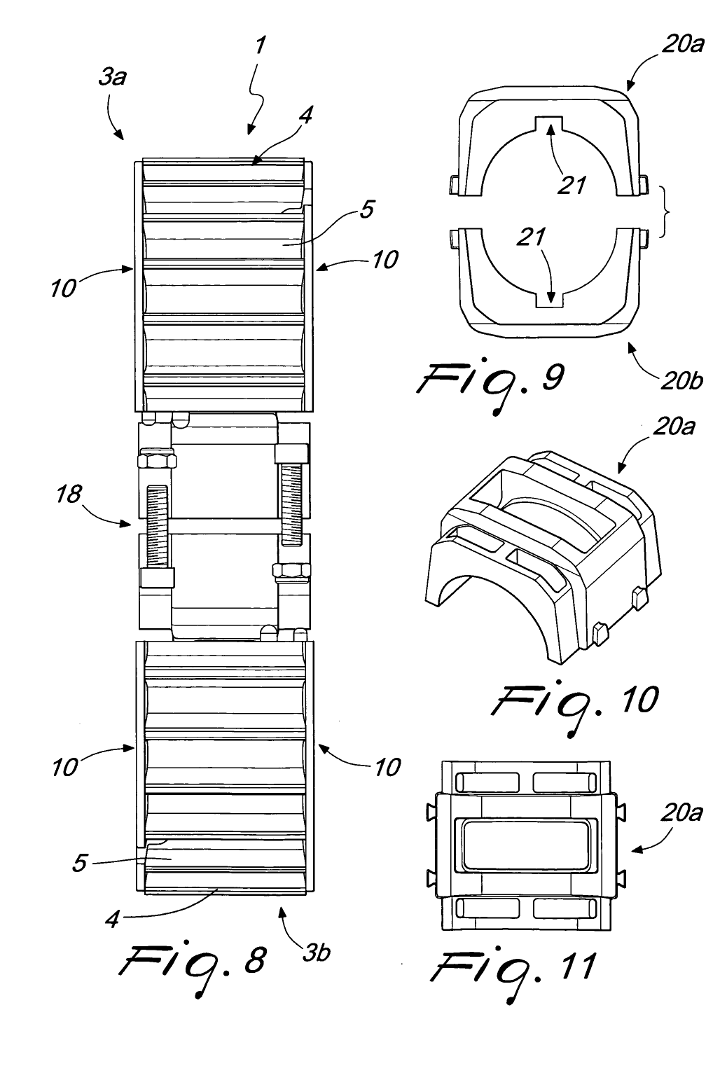

In the examples of embodiment that follow, individual characteristics, given in relation to specific examples, may actually be interchanged with other different characteristics that exist in other examples of embodiment.

Moreover, it is noted that anything found to be already known during the patenting process is understood not to be claimed and to be the subject of a disclaimer.

### DESCRIPTION OF THE PREFERRED EMBODIMENTS

With reference to the figures, the reference numeral 1 designates a sprocket, particularly for conveyor belts or chains.

The sprocket 1 comprises a spur gear 2, which is constituted by two mirror-symmetrical spur halves, designated respectively by the reference numerals 3a and 3b, which are substantially semicircular and from the curved outer surface 4 of which a series of teeth 5 protrude radially, said teeth being engageable for example with a conveyor belt or chain, not shown in the accompanying figures. Each one of the two spur halves 3a and 3b has, at the internal surface 6, a polygonal central seat 7 to which two substantially flat end faces 8 are contiguous, said end faces facing each other during use.

Once the two spur halves 3a and 3b have been arranged mutually adjacent at the end faces 8, the central seats 7 form an opening 9.

A recess 11 is formed on each one of the two lateral faces 10 of each one of the spur halves 3a and 3b and surrounds the central seats 7.

At right angles to each one of the end faces 8 there is a first pair of holes 13, which are connected at the region that is adjacent to the recesses 11 to a receptacle 14 for nuts 15.

Each spur half 3a and 3b comprises mutual centering means, constituted advantageously by two or more pairs of pins 16 and by two or more pairs of complementarily shaped second holes 17, which respectively protrude and are formed at the end faces 8.

Each pin of a spur half faces, during use, one of the second holes 17 formed in the other spur half.

The spur 1 further comprises interconnection means for detachably interconnecting the two spur halves 3a and 3b and for locking a hub 18, which are constituted advantageously by four pins 19, which can be interposed between the end faces 8 and have free ends which are threaded complementarily with respect to the nuts 15.

The hub 18 can be accommodated at the opening 9 of the spur gear 2 and is divided into two hub halves, designated respectively by the reference numerals 20a and 20b, which are shaped complementarily with respect to the central seats 7. Said hub halves advantageously are approximately shaped like an inverted letter C.

The hub halves 20a and 20b which constitute the hub 18 have, on their mutually facing surfaces, a radial slot 21 for keying a shaft, not shown in the accompanying figures, for example by interposing at least one key 22.

Operation is therefore as follows: with reference to the cited figures, the two hub halves 20a and 20b which constitute the hub 18 are arranged mutually adjacent and are then arranged within the central seat 7 formed by arranging mutually adjacent the two spur halves 3a and 3b after positioning one end of the pins 19 thereat.

As an alternative, each hub half is inserted in the corresponding spur half, locking therein by way of the mutual opposition of tolerances between the corresponding surfaces of the hub half and of the corresponding central seat 7; two spur halves are thus formed which are then mutually interconnected by interposing and locking the nuts 15.

The spur halves are thus mutually interconnected, locking the hub 18, by tightening the remaining nuts 15, laterally to the resulting sprocket, therefore without acting on its outer surface 4.

The hub 18 is therefore rotationally coupled to the spur gear 2 by way of the shape interference with respect to the central seat 7.

It has thus been found that the invention has achieved the intended aim and objects, a modular spur gear having been provided, particularly for conveyor belts or chains, in which the mutual locking of the hub and of the spur gear occurs by way of an interference which does not require providing holes radially to the spur gear.

The connection between the spur year and the hub occurs easily and rapidly, since it can be performed by acting on the means provided laterally to the spur gear and not radially thereto.

The simplicity, safety and speed of the provision of the interconnection can also be provided by personnel that is not particularly trained.

Finally, the absence of means for radial connection to the spur gear allows to obtain a sprocket which is free from problems of jamming with a conveyor belt or chain associated therewith, since said sprocket is free from machinings that might weaken its structure, so as to increase its operating lifespan.

The invention is of course susceptible of numerous modifications and variations, all of which are within the scope of the appended claims.

The materials used, as well as the dimensions that constitute the individual components of the invention, may of course be more pertinent according to the specific requirements.

The various means for performing certain different functions need not certainly coexist only in the illustrated embodiment but can be present per se in many embodiments, including ones that are not illustrated. The characteristics indicated as advantageous, convenient or the like might also be omitted or be replaced with equivalents.

The disclosures in Italian Patent Application No. TV2005A000061 from which this application claims priority are incorporated herein by reference.

What is claimed is:

1. A modular sprocket for conveyor belts or chains, comprising: a spur gear, which is constituted by two spur halves; a hub divided into two hub halves; an opening provided between said two spur halves and which can accommodate internally said hub, said opening having a polygonal cross-section, which is shaped complementary with respect to said hub; and interconnection means for interconnecting said spur halves and for locking said hub which are laterally accessible with respect to said sprocket.

2. The sprocket of claim 1, comprising the two spur halves, which are mutually mirror-symmetrical and are substantially semicircular, and wherein each one of said two spur halves has, at an internal surface thereof, a polygonal central seat to which two end faces are contiguous, said end faces being substantially flat and arranged so as to face each other during use.

3. The sprocket of claim 2, wherein the central seats of said spur halves form said opening having a polygonal cross-section upon arrangement of said two spur halves with said bases in mutually adjacent positions.

4. The sprocket of claim 3, comprising recesses which surround each said central seats and are formed on each lateral face of each one of said spur halves.

5. The sprocket of claim 4, further comprising receptacles provided in said spur halves, and two first holes formed at right angles to each one of said end faces, said interconnection means comprising nuts and said two first holes being each connected, at a region adjacent to said recesses, to the receptacle that are adapted to accommodate said nuts.

6. The sprocket of claim 5, wherein each one of said spur halves comprises centering means for mutual centering, which are constituted by at least two pairs of pins and by at least two pairs of complementarily shaped second holes, which respectively protrude from, and are formed at, said end faces.

7. The sprocket of claim 6, wherein each one of said pins of one of said spur halves faces, during use, one of said second holes provided in the other spur half.

8. The sprocket of claim 7, further comprising the inteconnection means for the detachable interconnection of said two spur halves and for locking said hub, which are constituted by four pins, said four pins being interposable between said end faces and having free ends which are threaded complementarily with respect to said nuts.

9. The sprocket of claim 8, wherein said hub is accommodatable at said opening and is divided into the two hub halves, which are shaped complementarily with respect to said central seats, said hub halves being shaped as an inverted letter C.

10. The sprocket of claim 9, wherein said hub halves have, on mutually facing surfaces thereof, a radial slot for keying a shaft with interposition of at least one key.
